(19) United States
(12) Patent Application Publication
(10) Pub. No.: US 2006/0080847 A1
(43) Pub. Date: Apr. 20, 2006

(54) Line marking means

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/968,220

(22) Filed: Oct. 18, 2004

(51) Int. Cl. B41G 3/00

(52) U.S. Cl. 33/34

(57) ABSTRACT

The line marking means comprises of a channel with an ink feeding system and an overflow control system in fluid connection with the channel which also functions as the ink applicator. The ink feeding system comprises of a reservoir that contains an ink to be delivered into the channel through one or more tubes. A flow control mechanism may be disposed between the reservoir and the channel to control the rate of delivery of the ink into the channel. The overflow control system comprises of one or more tubes that will remove the excess amount of ink from the channel and redeposit the excess ink back into the reservoir or the excess ink may be discarded. If the flow control mechanism has the capability to accurately control the rate of delivery of the ink into the channel, the overflow control system will not be necessary.

### BACKGROUND

1. Field of Invention

The present invention relates to a line marking means for marking one or more clear distinct lines on the absorbent tip of a cotton swab.

2. Description of Related Art

Cotton swabs with one or more absorbent tips are commonly used in households for cleaning ears, nose, wounds, small appliances, and for a variety of other applications. The absorbent tip on the cotton swab may be made of cotton, foam, or sponge. Generally, the absorbent tip is white in color with an elliptical profile and surrounds the end of the cotton swab tube symmetrically.

Various designs exist for differentiating one cotton swab from another. Some designs use different color cotton swab tubes. Generally, the tubes in these designs are made of plastic. Other designs use different color absorbent tips. The color absorbent tips on these designs can only have one color and the entire absorbent tip is dyed to that color. If more colors are used the colors will blend into each other at their intersections and result in a blur of colors due to the absorbent property of the absorbent tip. Also, the tip cannot have any designs such as a simple distinct line or a distinct spiral line on it. Many have attempted to mark distinct lines on the absorbent tip and failed. Attempts to mark a distinct line on the absorbent tip have resulted in a blurred band of color that will simply spread into the surrounding material due to the absorbent property of the absorbent tip. Marking a clear and distinct line on the absorbent tip of the cotton swab has been virtually impossible.

### BRIEF SUMMARY OF THE INVENTION

The present invention is a line marking means for marking one or more clear distinct lines on an absorbent tip of a cotton swab. Another object of the present invention is to imprint one or more clear distinct lines on the tip of a cotton swab. Yet another object of the present invention is to imprint one or more clear distinct spiral lines on the tip of a cotton swab. Another object of the present invention is to imprint one or more clear distinct lines on the tip of a cotton swab using only the necessary amount of ink without wasting any excess amount of ink.

The line marking means comprises of a channel with an ink feeding means and an overflow control means in fluid connection with the channel which also functions as the ink applicator. The ink feeding means comprises of a reservoir that contains an ink to be delivered into the channel through one or more tubes. A flow control means may be disposed between the reservoir and the channel to control the rate of delivery of the ink into the channel. The overflow control means comprises of one or more tubes that will remove the excess amount of ink from the channel and redeposit the excess ink back into the reservoir or the excess ink may be discarded. If the flow control means has the capability to accurately control the rate of delivery of the ink into the channel, the overflow control means will not be necessary.

### BRIEF DESCRIPTION OF THE DRAWINGS

FIG. 1 shows the preferred embodiment of the line marking means.

FIG. 2 shows an enlarged view of the preferred embodiment of the line marking means shown in FIG. 1.

FIG. 3 shows another embodiment of the line marking means.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

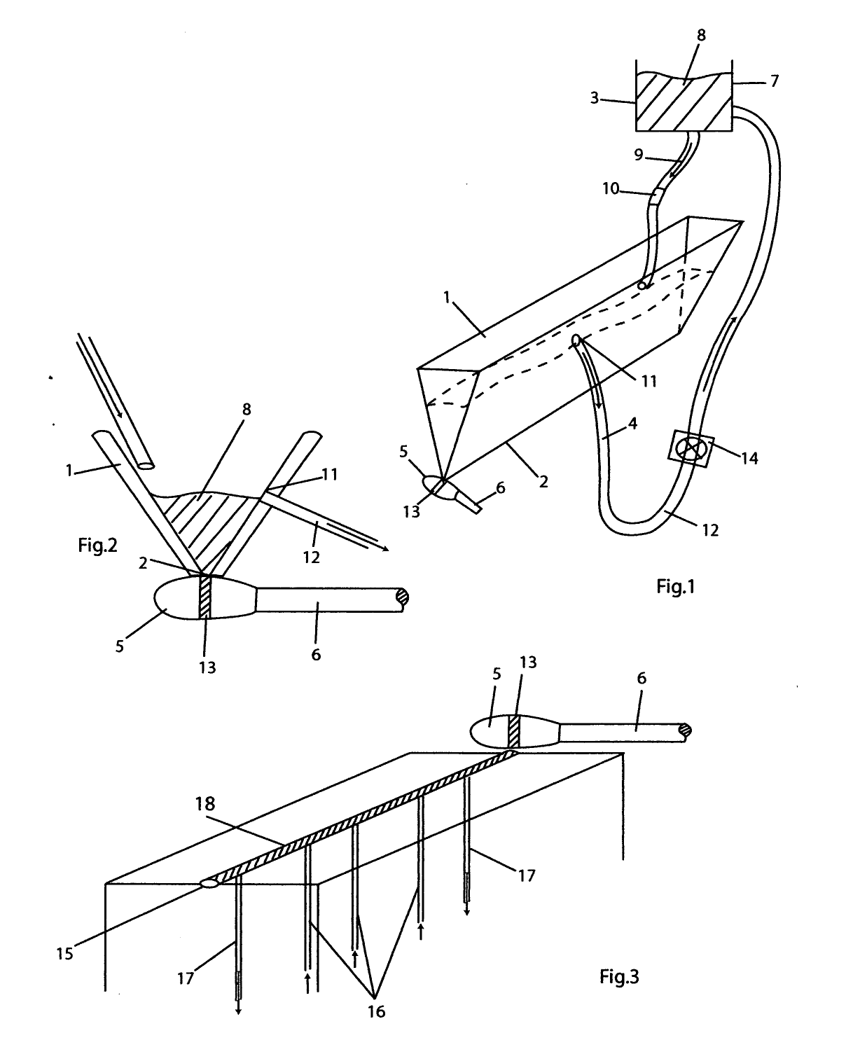

FIGS. 1 and 2 show the preferred embodiment of the line marking means. In the preferred embodiment, the line marking means comprises of a channel 1 with an elongated opening 2, which functions as an ink applicator, and with an ink feeding means 3 and an overflow control means 4 in fluid connection with the channel 1. The channel 1 is positioned generally above the absorbent tip 5 of the cotton swab 6 with the elongated opening 2 towards the absorbent tip 5 of the cotton swab 6. The ink feeding means 3 comprises of a reservoir 7 that contains an ink 8 to be delivered into the channel 1 through one or more tubes 9. A flow control means 10 such as a valve may be disposed between the reservoir 7 and the channel 1 to control the rate of delivery of the ink 8 into the channel 1. If the flow control means 10 has the capability to accurately control the rate of delivery of the ink 8 into the channel 1, the overflow control means 4 will not be necessary. If required, the overflow control means 4 comprises of an opening 11 in said channel 1 and one or more tubes 12 that will remove the excess amount of ink 8 from the channel 1 through the opening 11 in the channel 1 and redeposit the excess ink 8 back into the reservoir 7 or the excess ink 8 may be discarded. In another embodiment, the overflow control means 4 comprises of a small tube or a needle positioned at a predetermined height from the bottom of the channel 1 such that it will remove any excess ink 8 that reaches the predetermined height.

As the ink 8 in the channel 1 is being depleted by the imprinting of the line 13 on the absorbent tip 5 of a cotton swab 6, the ink feeding means 3 will continuously feed the channel 1 with more ink 8. In the preferred embodiment, the rate at which the ink 8 is being delivered into the channel 1 is controlled by the flow control means 10 to be the same as or slightly more than the rate of depletion of the ink 8 resulting in an excess of ink 8 that will accumulate in the channel 1. If the flow control means 10 has the capability to accurately control the rate of delivery of the ink 8 to be the same as the rate of depletion of the ink 8 from the channel 1, the overflow control means 4 will not be necessary. If the flow control means 10 is allowing ink 8 delivery of more than the rate of depletion of the ink 8, the accumulated ink 8 will increase in the channel 1 until it reaches an overflow control means 4. The overflow control means 4 may be simply an opening 11 at a predetermined position in the channel 1 whereby when the ink level reaches the opening 11, the excess accumulated ink 8 will be removed through the opening 11. A tube 12 may be connected to the opening 11 to direct the excess accumulated ink 8 that is removed from the channel 1 back into the reservoir 7 or the removed excess ink 8 may be discarded. The removal of the excess ink 8 may also be assisted by vacuum, such as with a vacuum pump 14 placed in line with the overflow control means 4. In another embodiment, the overflow control means 4 comprises of a small tube or a needle positioned at a predetermined height from the bottom of the channel 1 such that it will remove any excess ink 8 that reaches the predetermined height.

A distinct line 13 in the form of a ring may be formed on the absorbent tip 5 of the cotton swab 6 on the assembly line during the manufacturing process by rotating the absorbent tip 5 across the elongated opening 2 in the channel 1 and oriented perpendicular to the channel 1. With two or more channels, two or more distinct lines may be imprinted on the absorbent tip 5 of the cotton swab 6 when the absorbent tip 5 is rotated under the elongate openings of the channels and oriented perpendicular to the channels. Furthermore, different color inks may be used in the different channels to imprint lines of different colors on the same absorbent tip 5 of the cotton swab 6. The width of the elongated opening 2 may also be changed to imprint varying line widths on the absorbent tip 5. The width of the elongated opening 2 may also be adjusted to operate with ink 8 of varying surface tension since the ink 8 is held in the channel 1 at the elongated opening 2 by its own surface tension.

A spiral line may be imprinted on the absorbent tip 5 by orienting the channel 1 at an angle that is not perpendicular to the absorbent tip 5 of the cotton swab 6. When the cotton swab 6 is rotated across the elongated opening 2 in the channel 1, the channel 1 will imprint a spiraling line on the absorbent tip 5 of the cotton swab 6. With two or more channels, two or more distinct spiraling lines may be imprinted on the absorbent tip 5 of the cotton swab 6 when the absorbent tip 5 is rotated under the elongated openings in the channels and oriented at an angle that is not perpendicular to the channels. Furthermore, different color inks may be used in the different channels to imprint spiraling lines of different colors on the same absorbent tip 5 of the cotton swab 6.

FIG. 3 shows another embodiment of the line marking means. In this embodiment, the line marking means comprises of a channel 15 with an ink feeding means 3 and an overflow control means 4 in fluid connection with the channel 15. In this embodiment, the channel 15 is positioned below the absorbent tip 5 of the cotton swab 6. Optionally, an absorbent thread 18, such as a cotton thread, may be positioned within the channel 15 to evenly distribute the ink 8 in the channel 15 and to prevent overflowing of the ink 8 from the channel 15. The ink feeding means 3 comprises of a reservoir 7 that contains an ink 8 to be delivered into the channel 15 through one or more ink flow paths 16 into the channel 15. A flow control means 10 may be disposed between the reservoir 7 and the channel 15 to control the rate of delivery of the ink 8 into the channel 15. If required, the overflow control means 4 comprises of one or more ink flow paths 17 that will remove the excess amount of ink 8 from the channel 15 and redeposit the excess ink 8 back into the reservoir 7 or the excess ink 8 may be discarded. The removal of the excess amount of ink 8 may be from the bottom of the channel 15 or the side of the channel 15. The removal of the excess ink 8 may also be assisted by vacuum, such as with a vacuum pump 14 placed in line with the overflow control means 4.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.
What is claimed is:

1. A line marking means comprising:
a channel with an elongated opening;
an ink feeding means in fluid connection with said channel; and
an overflow control means in fluid connection with said channel.

2. A line marking means as in claim 1, wherein said ink feeding means comprises of a reservoir with an ink disposed therein.

3. A line marking means as in claim 1, wherein said ink feeding means is connected to said channel with a tube.

4. A line marking means as in claim 1, wherein a flow control means is disposed in fluid connection between said ink feeding means and said channel.

5. A line marking means as in claim 4, wherein said flow control means is a valve.

6. A line marking means as in claim 1, wherein said overflow control means is an opening in said channel and a tube connected to said opening.

7. A line marking means as in claim 6, wherein said tube is in fluid connection with said ink feeding means.

8. A line marking means as in claim 1, wherein a vacuum pump is in fluid connection with said over flow control means.

9. A line marking means as in claim 1, wherein an absorbent thread is disposed within said channel.

10. A line marking means comprising:
a channel with an elongated opening;
a reservoir with an ink disposed therein and in fluid connection with said channel; and
an opening in said channel to enable ink to be released from said channel.

11. A line marking means comprising:
a channel with an elongated opening;
an ink feeding means in fluid connection with said channel; and
a flow control means disposed in fluid connection between said ink feeding means and said channel.

12. A line marking means as in claim 11, wherein said ink feeding means comprises of a reservoir with an ink disposed therein.

13. A line marking means as in claim 11, wherein said ink feeding means is connected to said channel with a tube.

14. A line marking means as in claim 11, wherein said flow control means is a valve.

15. A line marking means as in claim 1, wherein an absorbent thread is disposed within said channel.
